(19) United States
(12) Patent Application Publication
(10) Pub. No.: US 2002/0100507 A1
(43) Pub. Date: Aug. 1, 2002

(54) Check valve for a piston pump

(75) Inventors: Manfred Hauser, Schwieberdingen (DE); Norbert Alaze, Markgroeningen (DE); Wolfgang Schuller, Sachsenheim (DE); Thorsten Duermeier, Vaihingen (DE); Peter Lang, Weissach (DE)

Correspondence Address: GREIGG & GREIGG P.L.L.C., 1423 Powhatan Street, Unit One, Alexandria, VA, 22314, US

(73) Assignee: Robert Bosch GmbH

(21) Appl. No.: 09/849,604

(22) Filed: May 7, 2001

(30) Foreign Application Priority Data
May 10, 2000 (DE) 1 00 22 811.9

(51) Int. Cl. F16K 15/00

(52) U.S. Cl. 137/540

(57) ABSTRACT

The invention relates to a check valve for a piston pump of a hydraulic traction-controlled vehicle brake system. The check valve is embodied in one piece as a helical spring with a closure disk on one face end of the helical spring and a base ring for fastening the check valve on another face end of the helical spring, and that the check valve be produced as a plastic injection-molded part.

### BACKGROUND OF THE INVENTION

1. Field of the Invention

The invention relates to a check valve for a piston pump intended primarily for use in a piston pump of a hydraulic vehicle brake system with traction control, but which be used anywhere for controlling a flow direction or preventing a reverse flow.

2. Description of the Prior Art

Many versions of check valves are familiar to one skilled in the art. In general, they have a valve closing body and a valve seat, on which when the check valve is closed. The valve closing body rests in sealing fashion on the seat, thus preventing a flow-through in one direction, and the valve closing body is lifted from the seat when the check valve is opened, so that a flow through the check valve is possible. Spring-actuated check valves exist, whose valve closing body is pressed against the valve seat by a helical valve spring, so that for opening the check valve, a pressure difference must be operative at the valve closing body, which lifts the valve closing body from the valve seat counter to the force of the valve closing spring. There are also springless check valves, whose valve closing body must be pressed against the valve seat by a pressure difference for closure.

The known check valves have the disadvantage that they must be put together from multiple component parts, and that guidance for the valve closing body is necessary, which guidance assures that upon closure of the check valve the valve closing body will come into contact with the valve seat in a way that closes the valve seat.

### SUMMARY OF THE INVENTION

The check valve of the invention has a helical spring whose windings rest on one another when the check valve is closed. The windings of the spring that rest on one another when the check valve is closed prevent a flow between the spring windings from the outside into an interior enclosed by the windings of the spring. When the check valve is open, the windings of the springs are lifted from one another, so that a flow out of the spring interior to the outside is possible between the windings. The term helical spring should also be understood to mean springs whose windings extend along an imaginary cylindrical jacket face. What is essential is that, when the spring is compressed, the windings rest on one another in order to prevent any through-flow between the windings.

The check valve according to the invention has the advantage that it can be produced simply, quickly and economically in one piece, thus omitting mounting steps for assembling the check valve. Another advantage of the check valve of the invention is that it rapidly makes a large flow cross section available upon opening, and that it closes quickly; it has good dynamic properties. Furthermore, the check valve of the invention is readily capable of miniaturization and is especially suitable as an inlet and/or outlet valve of a piston pump of a hydraulic vehicle brake system.

To attain good sealing action, in one feature of the invention, faces of the windings of the spring that face one another are embodied to be flat and parallel to one another, so that when the check valve is closed, the windings rest on one another superficially and not merely linearly. By way of example, the spring can have a rectangular or parallelogram-shaped winding cross section.

In a preferred feature, the check valve of the invention is produced as a plastic injection-molded part.

The check valve of the invention is intended as an inlet and/or outlet valve of a piston pump of a hydraulic vehicle brake system. In particular, the piston pump of the invention is intended as a pump in a brake system of a vehicle and is used in controlling the pressure in wheel brake cylinders. Depending on the type of brake system, the abbreviations ABS or ASR or VDC or EHB are used for such brake systems. In the brake system, the pump serves for instance to return brake fluid from a wheel brake cylinder or a plurality of wheel brake cylinders to a master cylinder (ABS), and/or to pump brake fluid out of a supply container into a wheel brake cylinder or a plurality of wheel brake cylinders (ASR or VDC or EHB). The pump is needed, for example, in a brake system with wheel slip control (ABS or ASR) and/or a brake system serving as a steering aid (VDC) and/or an electro-hydraulic brake system (EHB). With the wheel slip control (ABS or ASR), locking of the wheels of the vehicle during a braking event involving strong pressure on the brake pedal (ABS), and/or spinning of the driven wheels of the vehicle in the event of strong pressure on the gas pedal (ASR) can for instance be prevented. In a brake system serving as a steering aid (VDC), a brake pressure is built up in one or more wheel brake cylinders independently of an actuation of the brake pedal or gas pedal, for instance to prevent the vehicle from breaking out of the track desired by the driver. The pump can also be used in an electro-hydraulic brake system (EHB), in which the pump conveys the brake fluid into the wheel brake cylinder or wheel brake cylinders if an electric brake pedal sensor detects an actuation of the brake pedal, or in which the pump is used to fill a reservoir of the brake system.

### BRIEF DESCRIPTION OF THE DRAWINGS

The foregoing and other features of the invention will be apparent from the description contained below, taken with the drawings, in which:

FIG. 1 is a check valve of the invention in axial section; and

FIG. 2 is a schematic view of a piston pump with the check valve of FIG. 1 of the invention in axial section.

### DESCRIPTION OF THE PREFERRED EMBODIMENT

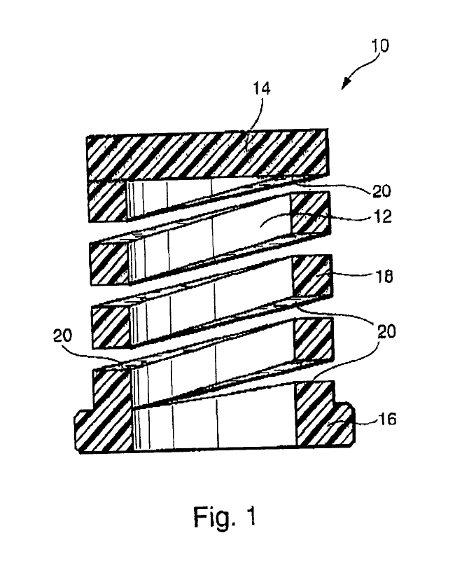

The check valve 10 of the invention, shown in FIG. 1, has a helical spring 12. As its closure element, the helical spring 12 has a closure disk 14 on one face end, and this closure disk is integral with the helical spring 12. On the other face end, a final or initial winding of the helical spring 12 is embodied in the form of a circumferentially closed base ring 16, which for the insertion of the check valve 10 into a receptacle, not shown in FIG. 1, such as a cylindrical recess, protrudes radially outward. The helical spring 12 with the closure disk 14 and the base ring 16, and thus the check valve 10 of the invention, are made of plastic in one piece by injection molding.

The helical spring 12 has a square winding cross section. As a result, surfaces 20, facing one another, of the windings of the helical spring 12, are flat and parallel to one another, so that when the helical spring 12 is axially compressed, the windings rest sealingly against one another. Surfaces 20 of the closure disk 14 and of the base ring 16 that face toward the windings of the helical spring 12 are also embodied in such a way that the windings of the helical spring 12, with their surfaces 20, rest sealingly on these surfaces 20 of the closure disk 14 and of the base ring 16 when the helical spring 12 is compressed.

The function of the check valve 10 of the invention is as follows: An inflow to the check valve 10 takes place through the base ring 16 into an interior between the windings of the helical spring 12. An overpressure in the interior forces the windings of the helical spring 12 apart, and a fluid flows out of the interior through to the outside between the windings of the helical spring 12. Conversely, if a pressure on an outside of the helical spring 12 and of the closure disk 14 is greater than in the interior, then the pressure forces the windings of the helical spring 12 against one another, so that the windings of the helical spring 12 rest sealingly on one another. Furthermore, the greater pressure on the outside of the closure disk 14 presses in a sealing fashion against the face end of the helical spring 12 and presses the helical spring 12 sealingly against the base ring 16. The check valve 10 is closed; it blocks any flow-through from the outside to the inside.

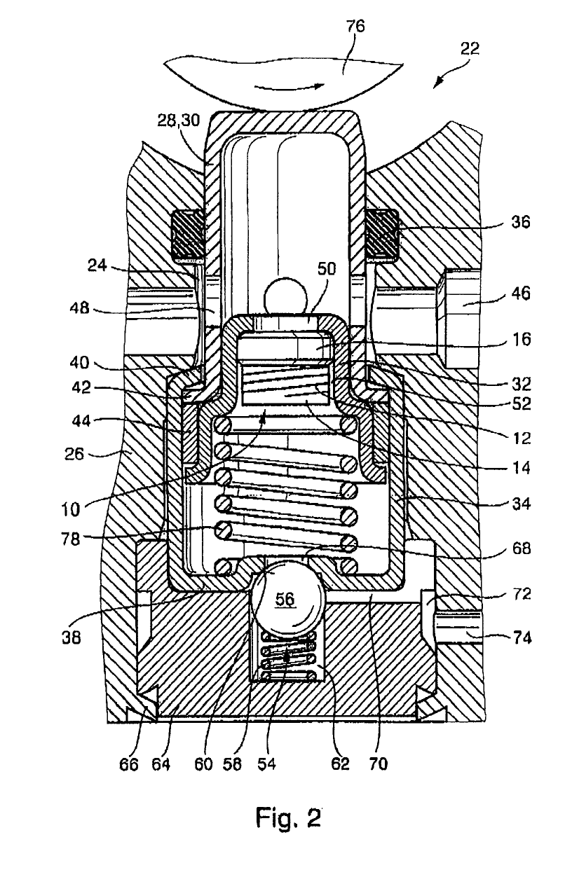

FIG. 2 shows the use of the check valve 10 of FIG. 1 in a piston pump 22 of a hydraulic vehicle brake system with traction control. The piston pump 22 is accommodated in a stepped pump bore 24 in a hydraulic block 26 of the vehicle brake system, not otherwise shown. Besides the piston pump 22, other hydraulic components, not shown, are accommodated in the hydraulic block 26, of which the drawing shows only a fragment surrounding the piston pump 22, and are hydraulically interconnected, such as magnet valves, hydraulic reservoirs, and damper chambers. The hydraulic block 26 is connected to a master cylinder, not shown, and wheel brake cylinders, not shown, are connected to the hydraulic block 26. The hydraulic block 26 forms a pump housing 26 of the piston pump 22 according to the invention and will hereinafter be called the pump housing 26. A piston 28 of the piston pump 22 is put together in two parts from an outer part 30 and an inserted inner part 32. The outer part 30 and the inner part 32 are produced in the form of sleeve-like, stepped shaped parts by means of deep drawing of sheet metal, and the inner part 32 is press-fitted into the outer part 30, such that it protrudes axially out of the outer part 30. The outer part 30 and the inner part 32 each have an end wall integral with them. An open face end of the inner part 32 faces away from the outer part 30.

The piston 28 is inserted into a bush 34 with the open face end of the inner part 32, which forms an open face end of the piston 28, and which in turn is inserted into the pump bore 24 in the pump housing 26. Over approximately two-thirds of its length, the piston 28 protrudes out of the bush 34 and is guided, axially displaceable, in the pump bore 24 and is sealed off by means of a sealing ring (quad ring) 36. The bush 34 is a cup-shaped shaped part, with a bush bottom 38, integral with the bush 34, on one face end, and with a shaped edge 40 protruding inward as a result of crimping, on an open face end. The edge 40, shaped toward the inside, retains the piston 28 in captive fashion in the bush 34 on an annular shoulder 42. The sealing and axial guidance of the piston 28 are effected with a sealing and guide ring 44, which is seated on the inner part 32, protruding from the outer part 30 of the piston 28, and is axially retained between the outer part and the inner part 32.

An inflow into the piston pump 22 is effected through an inlet bore 46, which is made, intersecting the pump bore 24, in the pump housing 26. From the inlet bore 46, fluid (brake fluid) flows through inlet holes 48, cut into the circumference of the outer part 30 of the piston 28, into the outer part 30 of the piston 28. From the outer part 30, the inflow to the piston pump 22 reaches the check valve 10 of the invention, which is inserted into the inner part 32, through a large-area through-hole 50 that is cut into the end wall of the inner part 32. The check valve 10 is inserted with its base ring 16 leading into the inner part 32; its base ring 16 rests on the end wall, having the through-hole 50, of the inner part 32. A press-fit exists between the base ring 16 of the check valve 10 and the inner part 32, so that the check valve 10 is secured in the inner part 32 by frictional engagement and clamping force. Since the base ring 16 protrudes radially past the helical spring 12 and the closure disk 14 of the check valve 10, there is an annular jacket space 52 between the check valve 10 and the inner part 32 of the piston 28, so that fluid passing through the check valve 10 can emerge from the check valve 10.

As described in conjunction with FIG. 1, when there is an overpressure on the side of the base ring 16, the check valve 10 can have a flow through it from the outer part 30 in the direction of the inner part 32 of the piston 28, if the pressure in the outer part 30 is higher than in the inner part 32, or in other words in the bush 34. This is the case in an intake stroke of the piston 28 in the direction out of the bush 34. If the piston 28 is moved into the bush 34 in a pumping stroke, then the pressure in the bush 34 and thus in the inner part 32 is greater than in the outer part 30, so that the check valve 10 blocks and prevents a reverse flow out of the bush 34 or inner part 32 into the outer part 30. The check valve 10 forms an inlet valve of the piston pump 22.

The check valve 10 of the invention, shown in FIG. 1, can in principle also be used as an outlet valve of the piston pump 22. In the exemplary embodiment of the piston pump 22 shown in FIG. 2, the outlet valve 54 is embodied as a conventional spring-loaded check valve, with a valve ball 56 that is pressed against a valve seat 60 by a valve spring 58 embodied as a helical compression spring. The outlet valve 54 is disposed in a blind bore 62 of a closure stopper 64 that is inserted into the pump bore 24 on an outside of the bush bottom 38. The closure stopper 64 is retained in the pump housing 26 by an encompassing calking 66. The closure stopper 64 retains the bush 34 in the pump bore 24 and closes the pump bore 24 in pressure-tight fashion on the side of the bush bottom 38.

The valve seat 60 of the outlet valve 54 is mounted on an outside of the bush bottom 38, at an orifice of a center hole 68 in the bush bottom 38. An outflow of fluid let out through the outlet valve 54 takes place through radial conduits 70 between the bush bottom 38 and the closure stopper 64, into a ring line 72, which surrounds the closure stopper 64 between one wall of the pump bore 24 and the closure stopper 64, and out of the ring line 72 into an outlet bore 74 made in the pump housing 26 radially to the pump bore 24.

For driving the piston 28, an eccentric element 76, which can be driven to rotate by an electric motor, is disposed on the face end of the piston that protrudes out of the bush 34; the closed end of the piston 28 is pressed against the circumference of this eccentric element by a piston restoring spring 78. The piston restoring spring 78 is embodied as a helical compression spring; it is inserted into the bush 34, braces itself on the bush bottom 38, and presses against the annular shoulder 42 of the piston 28 on the inside of the inner part 32 of the piston 28.

The foregoing relates to preferred exemplary of embodiments of the invention, it being understood that other variants and embodiments thereof are possible within the spirit and scope of the invention, the latter being defined by the appended claims.

1. A check valve for a piston pump comprising a structure including one piece a helical spring (12) whose windings rest on one another when the check valve (10) is closed and are separated when the check valve is open.

2. The check valve of claim 1, wherein said check valve (10) further comprising a closure element (14), which is disposed on one face end of said helical spring (12), said closure element being integral with said helical spring (12), whereby an outer winding of said helical spring (12) rests on said closure element when the check valve (10) is closed.

3. The check valve of claim 1, wherein said check valve (10) further comprising a base ring (16) disposed on one face end of said helical spring (12) and integral with said helical spring (12), whereby an outer winding of said helical spring (12) rests on said base ring when the check valve (10) is closed.

4. The check valve of claim 1, wherein the surfaces (20) facing one another of the windings of said helical spring (12) are parallel to one another.

5. The check valve of claim 1, wherein said check valve (10) is a plastic injection-molded part.

6. The check valve of claim 2, wherein said check valve (10) further comprising a base ring (16) disposed on one face end of said helical spring (12) and integral with said helical spring (12), whereby an outer winding of said helical spring (12) rests on said base ring when the check valve (10) is closed.

7. The check valve of claim 6, wherein the surfaces (20) facing one another of the windings of said helical spring (12) are parallel to one another.

8. The check valve of claim 7, wherein said check valve (10) is a plastic injection-molded part.
